(19) United States
(12) Patent Application Publication
(10) Pub. No.: US 2021/0153522 A1
(43) Pub. Date: May 27, 2021

(54) METHOD FOR OBTAINING PROTEIN PREPARATIONS FROM SUNFLOWER AND/OR CANOLA OILSEEDS, AND PROTEIN PREPARATION

(71) Applicant: FRAUNHOFER-GESELLSCHAFT ZUR FOERDERUNG DER ANGEWANDTEN FORSCHUNG E.V., Muenchen (DE)

(72) Inventors: PETER EISNER, Freising (DE); STEPHANIE MITTERMAIER, Moosburg a. d. Isar (DE); MICHAEL FRANKL, München (DE)

(21) Appl. No.: 16/643,684

(22) PCT Filed: Sep. 11, 2018
(86) PCT No.: PCT/EP2018/074407

§ 371 Date: Mar. 2, 2020

(30) Foreign Application Priority Data
Sep. 11, 2017 (DE) 10 2017 120 905.0

(51) Int. Cl. A23K 10/30; A23K 20/147; A23J 1/14; A23L 33/185

(52) U.S. Cl. CPC A23K 10/30; A23L 33/185; A23J 1/144; A23K 20/147

(57) ABSTRACT

The invention relates to a method for obtaining protein preparations from sunflower and/or canola seeds. At least the following steps are carried out:
dehulling sunflower or canola seeds up to a shell content of <5 mass. %;
partially deoiling the hulled sunflower or canola seeds in a mechanical manner by means of pressing up to a fat or oil content ranging between >7 and >35 mass. %; and
carrying out one or more extraction steps using at least one organic solvent or supercritical CO2.

These steps produce a further deoiling of the sunflower or canola seeds and is carried out after a previous comminution process or during a simultaneous comminution process of the pressed cake to a particle size of <2 mm or a flake thickness of <2 mm as a percolation or immersion extraction. A deoiled protein-containing meal or granulate with good protein digestibility is obtained as a result.

The invention relates to a method for obtaining protein preparations from sunflower and/or canola seeds of for use a as a food ingredient, as animal feed or as a technical additive, and a protein preparation that can be produced with the method.

### RELATED ART

Against the background of dwindling arable spaces and resources, plant-based protein preparations are becoming increasingly important as sources of nourishment for humans, for technical applications and for use in animal feed. The rising demand for high-value foodstuffs leads to a growing need for protein preparations which are optimised for nutritional purposes, which can be almost entirely metabolised by both humans and animals, and which can be produced easily and inexpensively.

One inexpensive source of proteins for food and animal feed are the residues from pressing and extraction operations carried out for obtaining cooking oil from sunflower and canola seeds. These seeds are characterized by a solid, predominantly dark coloured shell and an oil-containing fruit flesh. It is possible to shell these seeds, but the operation is very complicated particularly in the case of canola seeds.

The pressing and extraction residues which are created during oil recovery are used mainly as animal feed today. However, their use is very limited despite their high protein content. This is due in part to a very high shell content in the residue, which is above 25 wt %, and in exceptional cases may even be above 50 wt %. The proportion of undesirable accompanying substances is also very high, particularly the proportion of secondary plant substances such as polyphenols, tannins, glucosinolates or phytic acid. These components can constitute a combined total of more than 10 wt % of the residues and impair the colour, taste and digestibility of the proteins quite considerably.

Consequently, press cakes and extraction residues from the recovery of sunflower and canola oil are not suitable for producing high-value protein flours for food and animal feed, and are only suitable in small quantities for feeding certain kinds of animals due to the secondary plant substances they contain.

According to the related art, sunflower and canola seeds are processed mainly with a view to obtaining a high oil yield. To this end, they are first freed from dockage, partially conditioned (setting of a defined temperature and moisture level), then a preliminary oil extraction is carried out mechanically by pressing (residual oil contents not more than 10 wt %) after which the remaining oil content is extracted from the press cakes with hexane. “Finish pressing” may also be carried out to obtain residual oil contents of about 5 wt % without subsequent extraction, although the residual oil content in the press cakes reduces the storage stability of the residues.

According to the related art, sunflower and canola seeds are most often pressed without having the shell removed or only partially removed. In the case of partial shelling, more than 50 wt % of the shells contained in the seeds remain in the raw material before the oil is removed, which corresponds on average to a residual shell content before pressing of >10 wt % in sunflower seeds and >8 wt % in canola seeds. It is considered necessary in the related art particularly for pressing, i.e. finish pressing or preliminary pressing as a partial oil removal step, to have a shell content of at least 10 wt % in order to make it easier to drain the oil out of the press and so increase the pressing speed.

For several years, attempts have also been made to prepare protein flours or concentrates from the proteins contained in the residues obtained during recovery of sunflower or canola oil, and so make them usable for food and high-value animal feed applications. Some texts describe the production of protein concentrates from canola and sunflower seeds. These protein concentrates are recovered by dry or wet technical processing (e.g., with the use of solvents), wherein the protein remains in the residue. However, the high proportion of undesirable accompanying substances and the high crude fibre content limit the use of these residues as animal feed, so in many cases there does not appear to be a significant advantage over the sunflower and canola extract grist. Therefore, most protein concentrates have a limited application range and can only be used in low concentrations in animal feeds.

EP 2 885 980 B1 includes a description of a method for obtaining sunflower protein as a protein rich food or animal feed. In order to produce the animal feed, shelled sunflower seeds with a residual shell content of >5 wt % are used. The seeds are pressed until they have an oil content from ≥8 wt % to ≤18 wt % and a protein content from ≥30% to ≤45% relative to dry weight. The effect of the residual shell content on the digestibility of the proteins is not discussed. In this context too, it is assumed that the high crude fibre content and the high chlorogenic acid content of the product may severely limit its acceptance and thus also its usability as animal feed.

WO 2010097238 A2 also describes a method for producing protein preparations from shelled sunflower seeds. In this method, the sunflower seeds are shelled until a residual shell content of ≤5 wt % is obtained, or shelled sunflower seeds with a residual shell content of ≤5 wt % are supplied. A partial extraction of oil from the shelled sunflower seeds is carried out mechanically, by pressing, which is performed until a fat or oil content in the shelled sunflower seeds is in the range between 10 and 35 wt %. After one or more extraction steps with at least one solvent has/have been completed, a protein-containing flour with fat removed is obtained as the protein preparation. The protein preparation has very positive properties in terms of both appearance and function, which enable it to be used directly in the food or animal feed industry. Due to the low temperatures that prevail because pressing is carried out at below 80° C. and desolventizing at below 90° C., with this method good technofunctional properties are retained, a low degree of denaturing occurs, and consequently it may be expected that very good digestibility and bioavailability are achieved. However, the temperatures which prevail while processing the sunflower seeds are low, below 90° C., necessitating very long residence times in the solvent-related process stages during industrial implementation of the method, which in turn entail thermal damage and high costs for the overall process. This limits the usability of the preparations considerably and results in substantial financial disadvantages.

The problem addressed by the present invention is that of providing an efficient method for the production of qualitatively high-value protein preparations from sunflower and canola seeds. The preparations should contain proteins that are readily digestible, agreeable in terms of colour, taste and technofunctional properties due to the low contents of secondary plant substances and fibres, and due to the high protein content thereof meaning that the properties of the proteins are largely retained they should be usable in a wide range of foodstuffs and animal feeds but still inexpensive to produce.

### DESCRIPTION OF THE INVENTION

This problem is solved with the method according to claim 1. Claim 18 describes a protein preparation which can be produced with the method. The further claims describe preferred variants of the method and the protein preparation, and the preferred use of the protein preparations produced with the method.

For the present invention for obtaining high-value protein ingredients from sunflower and/or canola seeds, the seeds are first dehulled to a shell content <5 wt %, advantageously less than 2 wt %, advantageously less than 1 wt %, and particularly advantageously <0.1 wt %, and the shells are separated from the kernel by sieving, sifting and sorting. This ensures that low fibre contents, a pleasant taste, a bright colour and good functionality can be achieved. Alternatively, it is also possible to supply sunflower and/or canola seeds which have already been correspondingly dehulled and use these for the method.

After the seeds have been dehulled or supplied in the method according to the invention for obtaining protein preparations from sunflower or canola seeds, at least the following steps are carried out:
mechanical partial deoiling of the hulled sunflower or canola seeds by pressing up to a fat or oil content in the press cake in the range between >7 and <35 wt %, preferably between >8 and <35 wt %, particularly preferably between >10 and <35 wt %,
preferably separating water bound in the press cake out of the press cake up to a residual water content less than 5 wt %, particularly advantageously less than 2 wt %, and
carrying out one or more extraction steps using at least one organic solvent, preferably ethanol, propanol, methanol or hexane, or supercritical CO2 after a preceding or during a simultaneous comminution of the press cake to a particle size or flake thickness <2 mm to obtain a deoiled, protein-containing flour or granulate as protein preparation having a residual oil content of less than 4 wt %, advantageously <2 wt % (determined using the Soxhlet method).

At least one of the extraction steps is carried out during the method in such a manner that a further deoiling of the partially deoiled, dehulled sunflower or canola seeds is effected. In the course of the steps described, a temperature of 100° C. is not exceeded, advantageously not only the pressing but also the extraction (deoiling) and the desolventization which is performed after the extraction will take place with a temperature in the product (press cake or protein flour/protein granulate) below 90° C., particularly advantageously below 80° C., in order to largely preclude protein damage. Since the extraction is the process step with the longest duration, special care should be taken to ensure that during the extraction a temperature of 90° C. is not exceeded, advantageously it will be kept below 80° C., particularly advantageously below 70° C.

The functionality of the protein preparations obtained with the method is endowed with particular advantages if water is largely removed from the press cake before the one or more solvent extraction steps. Press cakes typically contain a proportion of 5 to 12 wt % water bound in the matrix after the pressing. Accordingly, if the press cake is treated so that the water content is reduced to less than 5 wt %, advantageously less than 3 wt %, particularly advantageously less than 2 wt %, the protein solubility after extraction is increased. In this context, the water may be separated by heating the press cake to temperatures between 60 and 100° C., advantageously between 70 and 90° C., by passing a substantially dry and/or warm gas stream at a temperature between 60 and 100° C., advantageously between 70 and 90° C. over the press cake, or by reducing the pressure in a receptacle in which a press cake is kept at a temperature >60° C., so that a part of the water contained in the press cake is separated by evaporation or vaporisation.

According to the invention, in the case of both canola and sunflower press cakes, solvent extraction takes place in an immersion or percolation extraction apparatus, advantageously in an immersion extraction apparatus, wherein the press cakes obtained after the pressing are comminuted before or advantageously during the solvent treatment substantially to the particle sizes or flake thicknesses indicated earlier.

After pressing according to the related art and also in the present method the press cake mostly has a thickness or particle size ranging from 0.4 to 4 cm, preferably from 0.5 to 2 cm by the time it exits the mechanical press in the form of small slices or strands.

It has been found that the percolation or immersion extraction with a solvent such as hexane or ethanol and also the desolventization of the solvent proceeds much faster and also more smoothly despite the low extraction temperatures, in some cases below 70° C., if the particle size is reduced to less than 2 mm, advantageously less than 1 mm, particularly advantageously less than 0.5 mm, ideally less than 0.2 mm, or the press cake is processed into flakes having a thickness of less than 2 mm, advantageously less than 1 mm, particularly advantageously less than 0.5 mm, ideally less than 0.2 mm.

For the purposes of the present patent application, a particle size of <2 mm is understood to mean that when sieving a representative random sample of the press cake particles obtained after comminution of the press cake with a sieve having a mesh size of 2 mm, 10% or less of the mass of all particles in the random sample is unable to pass through the sieve and 90% or more of the mass of the particles are deposited below the sieve. For a particle size of <1 mm and <0.5 mm, this then applies correspondingly for a sieve having a mesh size of 1 mm or 0.5 mm or 0.2 mm. If the comminution does not take place until a suspension with an organic solvent is supplied (e.g., by a stirrer), the sieve size analysis must be carried out using the suspension, possibly with the aid of a further solvent.

The term flake thickness is understood to mean the average thickness of the flakes which are obtained after flocking in a roller mill or some other apparatus used to squash or crush the press cake. The thickness of the flakes can be determined for example by measuring with a calliper or micrometer screw, the average thickness then corresponds to the arithmetical average from at least 50 measurements in a representative random sample.

In this context, the particle size of the comminuted press cake may be adjusted in various ways to suit the variant of extraction according to the invention. Thus, crushing devices or mills such as hammer mills, impact mills or granulators with corresponding sieve inserts, or roller mills with appropriate roller gaps may be used before the extraction. As a result, particle charges with a certain size spectrum are obtained. These may then undergo further treatment after or during the comminution by fractionating according to size, e.g., by means of sieving or sifting, to render the particle size distribution more uniform.

Flowing liquids in a stream or, particularly advantageously, solid-containing dispersions may also be used for the comminution. Simple stirring, mixing or transporting units intended for stirring or pumping the solvent, for example, may also be used for the comminution. Thus, it is possible to use devices for comminution which are provided for transporting media, such as screw conveyors, pneumatic conveyors or centrifugal pumps for example. Possibly on the basis of prior tests, the person skilled in the art will be able, to select the mechanical load and the duration of the treatment in mechanical units of such kind so that the comminution of the particles according to the invention is achieved.

A further possible method of comminution is to flock the press cake, which can be carried out in a pressing apparatus or by means of a roller mill. In this process, particles of different sizes and press cakes of different shapes are rendered uniform by being passed through a gap with defined thickness or pressed between two plates. In the case of a roller mill, the particles are drawn into the gap which is between two rotating rollers. After this treatment, the press cake has the form of wafers or flakes with a substantially defined thickness.

Surprisingly, it was found that after dry grinding or flocking of the press cakes to the abovementioned particle sizes or flake thicknesses, or during a simultaneous comminution of the particles during the extraction (for example by a stirrer other mechanical input method) to these particle sizes, a particularly gentle deoiling is enabled despite the input of mechanical energy. A consequence of the comminution operation is that the longer the comminution continues the shorter the time for which the press cake must undergo extraction, with the result that the press cakes can remain in the extractor for less time, and the solvent-related damage to the protein contained in the press cake is reduced. In such case, it is particularly advantageous if the comminution of the particles is accompanied by substantially even shearing through the entire solvent-press cake mixture, which has the effect of increasing the speed of extraction and the solvent-related damage can be reduced further.

As explained above, during processing the press cake or extraction residue is comminuted to a particle size or flake thickness of less than 2 mm, advantageously less than 1 mm, particularly advantageously less than 0.5 mm, ideally less than 0.2 mm. In this context, it was found that the duration of the extraction process may be shortened from several hours to a few minutes if the particles are already comminuted appropriately. Because of the shorter extraction period, the proteins are exposed to considerably less stress, as the influence of temperature and solvent can be reduced from several hours to a few minutes. Consequently, the preparations obtained with the method according to the invention exhibit better solubility during subsequent use, and in most cases they present better properties in terms of binding water, binding oil, and foaming and emulsifying capacity than the preparations that are extracted from whole lumps of press cake that have not been comminuted, some of which have edge lengths over 1 cm, extracted up to an oil content below 3 wt % over several hours and subsequently desolventized, that is to say from which the solvent is removed.

According to the related art, it is undesirable to introduce finer particles with a size less than 1 mm into the process, because fine particles can cause product losses due to dust generation or suspended abraded particles. Therefore, the particles used in existing systems according to the related art usually have a diameter or edge length of more than 1 cm.

In the method according to the invention, this previously undesirable comminution is chosen deliberately in order to minimise the exposure of the proteins to the stresses of temperature and solvent. Despite the finer particle size, it is still possible by suitable measures to minimise the losses due to fine abraded particles which can get into the oil phase through the mixture of solvent and oil (miscella). These measures will be described in the following text.

In this respect, particular advantages are offered by multistage immersion extraction. In this process, the press cakes are completely immersed in the solvent, so that dust cannot form during the extraction. It is also possible in an immersion extractor to carry out the comminution of the particles in targeted manner with an agitator. This in turn introduces the capability of stepped comminution over several extraction stages. After the first immersion extraction of the press cake, the solvent and the solid can be separated from each other mechanical. The oil-containing can be desolventized and used again for deoiling another comminuted press cake, the press cake which has been separated from the solvent can be treated again with fresh solvent, so that still more oil can be extracted. The solvent fractions from the treatment of a solid which already contains less oil can be reused for extraction with a solid which contains more oil, thus reducing the total solvent requirement. This is called counterflow extraction.

The first extraction stage in the multistage immersion extraction of the suggested method is preferably carried out without stirring.

Another advantage of the immersion extraction process presents itself due to the option to use the sedimentation specifically for the separation chutes or for the degree of separation of the solid-liquid mixture. In this context, after the extraction, which is performed in a solvent-press cake suspension with defined particle sizes, a sedimentation up to a defined volume ratio of solid phase and residue is carried out in the earth gravitation field after the dispersion apparatus (stirrer for example) has been switched off. The residue is separated when the volume proportion of the residue is at least 50%, advantageously >60%, particularly advantageously >70%. Solvent is added to the sediment again, the mixture is stirred until a new particle size distribution is established by the effect of shearing during the dispersion, for example by means of an agitator. Afterwards, the sedimentation process starts again.

Surprisingly, the second sedimentation process is completed just as quickly as the first despite the smaller particles, assisted in part by the fact that the oil content in the residue is lower than in the first sedimentation. The cycle of suspension-extraction-sedimentation is repeated several times, advantageously more than twice, preferably more than 3 time, particularly advantageously more than 4 times.

Thus, in counterflow operation, in a first extraction stage the press cake that has not undergone any deoiling may be left in coarse lumps and only comminuted to a small degree, if at all to avoid product losses via the miscella. Once they have undergone preliminary extraction, the press cakes are then comminuted further with the aid of an agitator in the following stages until the particle size according to the invention is reached. In counterflow operation of press cake and solvent, the finer particles may then be held back in the individual raffinates to prevent them from getting into the miscella, which is separated from non-comminuted particles in the first stage.

The desolventization—that is to say the separation by distillation of the solvent from the deoiled press cake—may be shortened considerably with the method according to the invention. When the press cakes are comminuted according to the invention, it is possible to reduce the solvent content in the protein preparation, that is to say in the deoiled, protein-containing flour or granulate, from over 10 wt % to less than 1 wt % within a few minutes and without significant protein damage, even if the temperature of the press cake or protein preparations is set to less than 100° C. during desolventization.

At all events, when the method according to the invention is implemented, extraction and solvent separation has been found to take place considerably faster due to the substantial comminution of the particles, so that the temperature-time load at the same temperature may be reduced by at least 30%, in many cases by more than 90%.

In an advantageous variation of the method, an immersion extraction is carried out in a stirring tank, wherein the peripheral speed of the agitator is faster than 10 cm/s, advantageously faster than 50 cm/s, particularly advantageously faster than 1 m/s. With shearing loads of such magnitude in the stirring tank, it is possible to comminute press cakes with high mechanical strength easily and quickly.

For good comminution, the speed of the solvent jet which is sprayed onto the press cake body in the case of percolation extraction may also be set to such a level that the press cake is comminuted thereby. This is assured advantageously with jet speeds greater than 0.25 m/s, the solvent is particularly advantageously sprayed onto the press cake body at a speed greater than 1 m/s, preferably greater than 2 m/s. In this way, a comminution according to the invention may be achieved highly effectively.

It is also possible to comminute the mixture of solvent and press cake with the aid of a pump, for example by passing some of the suspension or all of the suspension through a centrifugal pump.

In all cases in which an immersion extraction is implemented, the weight ratio of solid to liquid should be varied in the range from 50:50 to 10:90. Particularly in the case of higher solid proportions in the suspension, rapid comminution is enhanced by the introduction of mechanical energy, by stirring for example.

Ethanol will be used for preference as the solvent for high-value protein ingredients, because ethanol extraction results in an improvement of the ingredients' taste. Since pure ethanol is very expensive, ethanol with a water content is used to good effect, advantageously a water content less than 10 wt %, particularly advantageously less than 5 wt %. Ethanol with low water contents has the advantage that quantities of polar substances such as oligosaccharides or secondary plant substances can also be flushed out of the press cake as well as the oil. This has the effect of improving the taste and colour of the ingredients while most of the proteins do not undergo denaturing. In contrast, extensive denaturisation of the proteins has been found to occur with high water contents of 30 wt % or more, for example.

During extraction with ethanol, an attempt will also be made to minimise the drying time during desolventization in order to avoid protein damage. This may result in ethanol residues are left in the protein preparation. Although this is not really desirable as such, samples with higher ethanol contents have been found to have improvements of their functional properties. Therefore, the proteins according to the invention are intended to contain ethanol residues. Thus, the ethanol content in the protein preparation should be more than 50 mg/kg, advantageously more than 500 mg/kg, particularly advantageously more than 5,000 mg/kg. Despite the ethanol contained, the sensory and functional properties of the protein preparations are surprisingly good.

It has been found that the protein preparations treated with ethanol in this way have particular advantages with regard to colour, and also in some functional properties.

Thus for example preparations with an ethanol residue content greater than 50 mg/kg have a particular lightness (L value in the L*a*b colour analysis). A protein preparation in the ground, powdered state according to the invention has a lightness L* of at least 80, preferably at least 85 and particularly preferably at least 90. The preparation also has a protein content of more than 45 and less than 80 wt %, an oil content less than 4 wt % (determination with the Soxhlet method), and despite the ethanol it contains, a protein solubility of more than 25% and emulsifying capacity of more than 400 ml oil per gram of protein. The analysis methods used correspond to the methods described in specification EP2400859.

In the following text, two embodiments in which protein preparations have been obtained from sunflower and canola seeds according to the suggested method will be described far exemplary purposes.

### Embodiment 1

50 kg of a sunflower press cake with a shell content <0.1 wt % and an oil content of 20 wt %, which was obtained using a press at a kernel temperature of the press cake of 70° C. and which consists of cylindrical pieces with a diameter of 5 mm and an average length of 3 cm, was dried for 20 minutes at a temperature of 80° C. in a vacuum (100 mbar) until it had a water content of 3 wt %. In the following step, 100 kg ethanol at a temperature of 60° C. was added to the press cake. In the first stage, the suspension was not stirred, in order to avoid the formation of ultrafine particles by comminution. The suspension was allowed to stand for 90 minutes, then the oil-containing residue (miscella) was separated and subsequently evaporated to enable recovery of the solvent. The sediment from which the miscella had been removed was charged with ethanol again, and the suspension was suspended with a blade stirrer for 30 minutes at a peripheral speed of 40 cm/s.

Consequently, the particles were successfully comminuted to a particle size less than 2 mm. Afterwards, the suspension was allowed to stand for 30 minutes so that the particles settled to form a substantially solid sediment bed. The supernatant above the sediment was separated and replaced with new solvent. This operation was repeated 4 times, with the result that the oil content in the press cake at the end of the 5th extraction was less than 2 wt %. After the 5th extraction, the particle size was <1 mm.

### Embodiment 2

150 kg hexane were added to 50 kg of a canola press cake with a shell content of 1 wt %, an oil content of 15 wt % and a water content of 2.5 wt %, which was obtained using a press with a kernel temperature of the press cake of 70° C., and was predried in the warm airstream, and which consisted of cylindrical pieces having a diameter of 4 mm and an average length of 1 cm. The solid-liquid mixture was circulated for 30 minutes by pumping with a centrifugal pump at a displacement speed of 5,000 litres per hour, and suspended in the process. Afterwards, the suspension was allowed to stand for 30 minutes so that the particles settled to form a substantially solid sediment bed. The supernatant above the sediment was separated and replaced with new hexane. This operation was repeated 3 times, with the result that the oil content in the press cake at the end of the 4th extraction was less than 3 wt %. The particle size was 0.5 mm.

1. A method for obtaining protein preparations from sunflower and/or canola seeds with the following steps
dehulling the sunflower or canola seeds up to a shell content of <5 wt % to obtain dehulled sunflower or canola seeds, or suppling dehulled sunflower or canola seeds with a shell content of <5 wt %;
partially deoiling the dehulled sunflower or canola seeds mechanically by pressing up to a fat or oil content of the dehulled sunflower or canola seeds in the range from >7 to <35 wt %; and
carrying out one or more extraction steps using at least one organic solvent or supercritical CO2, wherein
at least one of the extraction steps produces further deoiling of the partially deoiled, dehulled sunflower or canola seeds and is carried out as a percolation or immersion extraction process after a previous or during a simultaneous comminution of a press cake obtained by the mechanical partial deoiling to a particle size <2 mm or a flake thickness <2 mm, and
a deoiled, protein-containing flour or granulate is obtained as protein preparation with a residual oil content <4 wt % by means of the one or more extraction steps after a desolventization process.

2. The method according to claim 1,
characterized in that
after the mechanical partial deoiling and before the performance of the one or more extraction steps, bound water in the press cake is separated from the press cake until the residual water content is less than 5 wt %, preferably less than 2 wt %.

3. The method according to claim 1,
characterized in that
the comminution of the press cake is carried out up to a particle size <1 mm, preferably <500 μm.

4. The method according to claim 1,
characterized in that
a temperature of the dehulled sunflower or canola seeds is kept at <90° C. during the mechanical partial deoiling and the one or more extraction steps.

5. The method according to claim 1,
characterized in that
the extraction steps are carried out in the form of a multistage immersion extraction.

6. The method according to claim 5,
characterized in that
a stepwise comminution of the press cake is carried out over several extraction stages of the multistage immersion extraction.

7. The method according to claim 5,
characterized in that
the first extraction stage of the multistage immersion extraction is carried out without stirring.

8. The method according to claim 5,
characterized in that
the multistage immersion extraction is performed in counterflow operation of press cake and solvent.

9. The method according to claim 5,
characterized in that
in the multistage immersion extraction, after a first extraction stage, a sedimentation is carried out up to a volume ratio between sediment and supernatant in which a volume proportion of the supernatant is equal to >50%, advantageously >60%, particularly advantageously >70%, and when this volume ratio is reached the supernatant is separated, and in one or more further consecutive extraction stages the sediment obtained from each previous extraction stage is dispersed in solvent again, until due to shearing during the dispersion a new particle size distribution is established, a repeated sedimentation is carried out until a volume ratio between sediment and supernatant in which a volume proportion of the supernatant is equal to >50%, advantageously >60%, particularly advantageously >70%, after each further extraction stage, and when this volume ratio is reached the supernatant is separated.

10. The method according to claim 9,
characterized in that
more than two, preferably more than three of the further extraction stages with the steps of dispersing the sediment obtained in the previous extraction stage and subsequent sedimentation and separation of the supernatant are performed.

11. The method according to claim 1,
characterized in that
the immersion extraction is carried out in a stirring tank which includes an agitator, wherein the agitator is set to a peripheral speed of >10 cm/s during the extraction.

12. The method according to claim 1,
characterized in that
a ratio of proportions by weight of solid to liquid is set to a range between 50:50 and 10:90 during the immersion extraction.

13. The method according to claim 1,
characterized in that
the percolation extraction is carried out with a solvent jet which also causes the comminution of the press cake and is set to a jet speed of >0.25 m/s.

14. The method according to claim 1,
characterized in that
the at least one extraction step for the further deoiling of the partially deoiled, dehulled sunflower or canola seeds is carried out with ethanol or an aqueous ethanol solution as solvent.

15. The method according to claim 14,
characterized in that
an aqueous ethanol solution with a mass percentage by weight of <10 wt % water, advantageously <5 wt % water is used.

16. The method according to claim 14,
characterized in that
the delsolventization is carried out up to an ethanol content which is still more than 50 mg/kg, advantageously more than 500 mg/kg, particularly advantageously more than 5,000 mg/kg.

17. Protein ingredient in foodstuffs or animal feeds, which comprises a protein preparation produced in the method according to claim 1.

18. A protein preparation; which is obtained from the proteins of sunflower or canola seeds and has
an ethanol content of >50 mg/kg,
a protein content of >45 wt % and less than 80 wt %,
an oil content of <4 wt % and
a lightness value (L*) according to the CIE L*a*b*-colour space of ≥80.

19. The protein preparation according to claim 18,
characterized in that
it has a protein solubility of <25% and an emulsifying capacity of more than 400 ml oil per gram protein.

20. The protein preparation according to claim 18,
characterized in that
it has a lightness value (L*) according to the CIE-L*a*b* colour space of ≥85, preferably ≥90.
